(19) United States
(12) Patent Application Publication
(10) Pub. No.: US 2014/0187285 A1
(43) Pub. Date: Jul. 3, 2014

(54) COMMUNICATION SWITCHING

(71) Applicant: APPLE INC., Cupertino, CA (US)

(72) Inventor: Raghuveer MALLIKARJUNAN, Cupertino, CA (US)

(73) Assignee: APPLE INC., Cupertino, CA (US)

(21) Appl. No.: 13/731,718

(22) Filed: Dec. 31, 2012

(51) Int. Cl. H04W 88/06

(52) U.S. Cl. CPC H04W 88/06
USPC 455/552.1

(57) ABSTRACT

A method includes communicating data through a transceiver configured in a first mode specifying and allocating to at least one destination device, parsing the received data, determining whether the data contains a switching message. If the data contains the switching message, the controller may switch the transceiver to a second mode according to the switching message. If the data does not contain the switching message, applications may process the data received in the first mode.

### BACKGROUND

As new communication standards and protocols develop to increase bandwidth and speed, there is a need to build communication equipment and devices to be backward compatible to handle older and newer standards and protocols, so to allow users to gradually transition from older equipment and devices to newer ones.

To handle multiple different communication standards and protocols, the communication equipment and devices may need to use limited hardware sources to switch between the different standards and protocols. For example, such switching may include the Circuit-Switch Fallback (CSFB) in Evolution-Data Optimized or Evolution-Data Only (EV-DO, EV, EVDO, etc.) standard, to switch between data and voice communications, which may require retuning of transceiver hardware to different frequencies.

In a 1x/EVDO hybrid communication device, when EVDO communication is established (i.e. in data traffic), the EVDO traffic channel may be suspended periodically, and the transceiver is then retuned to a 1x (IS2000) channel frequency to monitor 1x paging signals to see if the communication device is receiving an incoming voice call. 1x paging signals may be broadcasted commonly in at least one paging channels or slots. Broadcasting typically refers to a way of sending a message open-ended to recipients without specifying any specific destinations or recipients.

This “tune-away” may occur periodically (for example, every Slot Cycle Index), and may cause lower data throughput due to disruption to the traffic channel. This may also increase power consumption as the device needs to retune the radio frequency (RF) channel resources to the 1x frequency and then tune back to the EVDO channel frequency periodically.

Therefore, there is a need for an improved way of switching communication standards and protocols.

### BRIEF DESCRIPTION OF THE DRAWINGS

FIG. 1 illustrates a device in accordance with an embodiment of the present disclosure.

FIG. 2 illustrates a method in accordance with an embodiment of the present disclosure.

FIG. 3 illustrates a method in accordance with an embodiment of the present disclosure.

### DETAILED DESCRIPTION

According to an embodiment, a device may include a transceiver communicating data in a first mode, the first mode specifying and allocating to at least one destination device, and a controller parsing application data from the data received in the first mode and determining whether the data contains a switching message. If the data contains a switching message, the controller switches the transceiver to a second mode according to the switching message, and if the data does not contain a switching message, applications process the data received in the first mode.

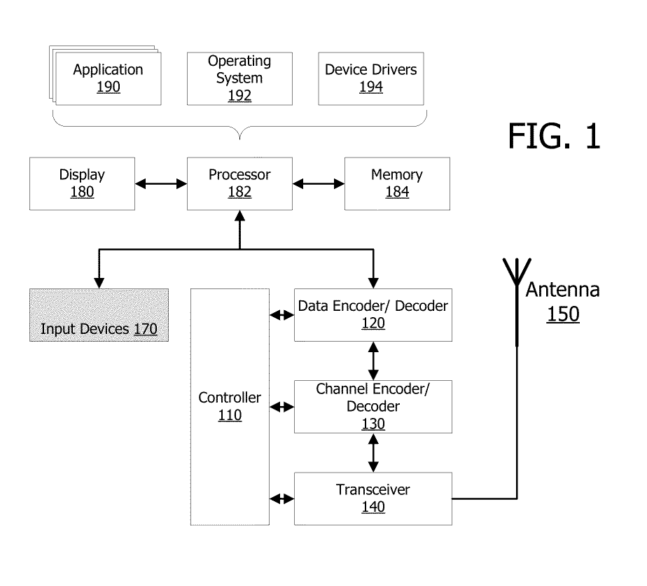

FIG. 1 is a functional block diagram of a device 100 in accordance with an embodiment of the present disclosure. The device 100 may include a controller 110, a data encoder/decoder 120, a channel encoder/decoder 130, a transceiver 140, and an antenna 150, coupled to each other, configured to implement the methods in accordance with the embodiments of the present disclosure. The transceiver 140 may transmit and receive data via the antenna 150. The data encoder/decoder 120 may encode or decode data streams to communicate directly with various software applications. The channel encoder/decoder 130 may encode or decode data channels according to various communication protocols to communicate directly with a wireless network (not shown). The controller 110 may parse application data from the data received, using the channel encoder/decoder 130 and the data encoder/decoder 120.

FIG. 1 is a simplified block diagram only. The components illustrated in FIG. 1 further include a processor 182, a memory 184, a display 180, and input devices 170. The processor 182 may parse application data from data streams, and process the application data using various software components, such as device drivers 194, operating system 192, and applications 190. The processor 182 executing software components may communicate directly with the data encoder/decoder 120 to encode or decode data streams. The data encoder/decoder 120 may communicate directly with the channel encoder/decoder 130 to encode the data stream in channels or decode channels into data streams. Encoded data channels may be transmitted or received via the transceiver 140 and the antenna 150.

The device 100 may be a mobile user device, such as a mobile phone, smart phone, tablet computer, pager, or portable computer. The device 100 may receive pending communication in the second communication, upon a user input on device 100 or on another device (not shown) communicating with the device 100. For example, the user may initiate a voice call on the device 100, may receive a voice call on the device 100 sent by another device communicating with the device 100, or may initiate data sessions to upload or download digital content.

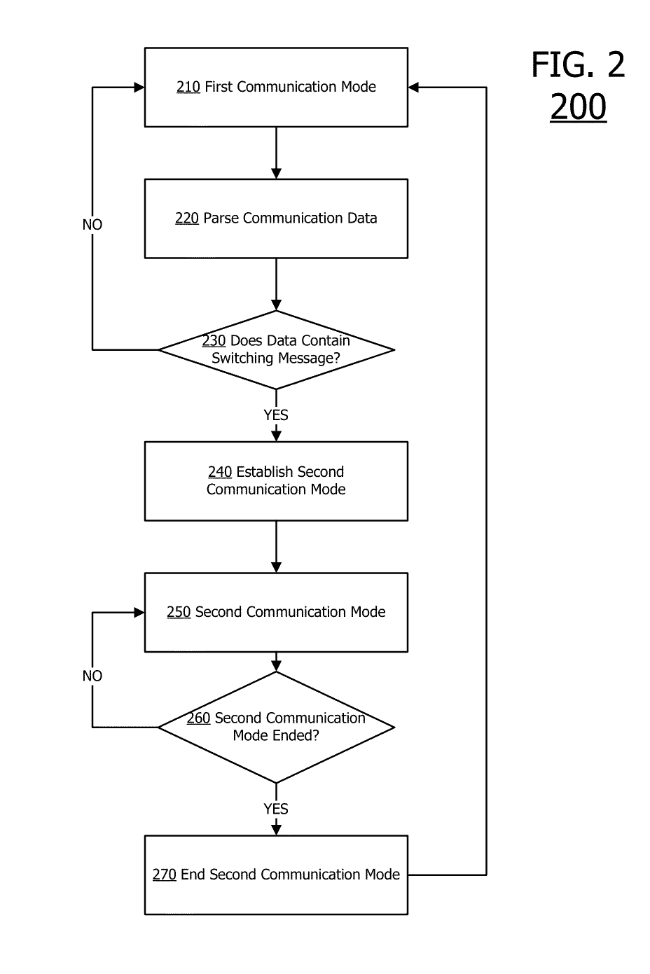

FIG. 2 illustrates a method 200 in accordance with an embodiment of the present disclosure.

The method 200 may include communicating data through the transceiver 140 configured in a first communication mode specifying and allocating to at least one destination device (block 210), and parsing the received data (block 220). The controller 110 may determine if the data contains a switching message or not (block 230). If the data does not contain a switching message, the method may process the received data by an application executing in the processor of the device (block 210).

If the data contains a switching message, at block 240, the controller 110 may switch the transceiver 140 to a second communication mode according to the switching message to establish the second communication mode.

According to an embodiment, the method may proceed to block 250, where a communication may be performed in the second communication mode. At block 260, if the second communication mode has not ended, the method may continue at block 250. At block 270, if the second communication mode has ended, the second communication mode may end, and the method may return to the first communication mode in block 210.

According to an embodiment, the first communication mode may be a data mode, and the data may be received via a plurality of traffic channels to support applications. The second communication mode may be a voice mode. The first and second communication modes may include different communication standards and protocols. For example, the first communication mode may be a EVDO (data only) mode using EVDO standards, and the second communication mode may be a 1x (IS2000) mode.

The device 100 may be communicating data through the transceiver 140 already configured in the first communication mode, for example EVDO (data only) mode through EVDO traffic channels. Such data traffic channels may be dedicated or allocated to one or more specific destination devices. This type of data communication may include for example, unicast type transmission and multicast type transmission. Unicast transmission typically refers to the sending of data to a single specific destination in a single transmission from the source. Multicast transmission typically refers to the sending of data to multiple specific destination device simultaneously in a single transmission from the source. For example, EVDO data traffic channels are dedicated or allocated to specific destination devices when the channels are established between the source device and the specific destination devices.

The data communicated through the allocated channels in first communication mode need not specify the destination devices. As the channels may already be allocated to the specific destination devices, the destination devices may be aware of which data stream and channels are intended for each of them. Thus, the controller 110 may parse the data communicated in the data channel allocated specifically for device 100, and determine if the data contains the switching message. In such a configuration, the switching message itself also need not specify any specific destination device.

The second communication mode may be a voice mode, such as the 1x (IS2000) mode. The device 100 may communicate in the second communication mode, using traffic channels traffic channels dedicated or allocated to one or more specific destination devices.

The controller 110 may switch and configure the transceiver 140 to the second communication mode based on the switching message. The switching message itself may include all of the information necessary for the controller 110 to configure the transceiver 140 in the second communication mode, without causing the transceiver 140 to receive paging information from the paging channels. In this configuration, the controller 110 may switch the transceiver 140 from one unicast/multicast mode to a different unicast/multicast mode, without using any broadcast mode.

Alternatively, the switching message may cause to the controller 110 to configure and cause the transceiver 140 to monitor and receive paging information from the paging channels, in order to further configure the transceiver 140 based on the paging information to set up the voice communication in the second communication mode. In this configuration, the controller 110 may switch the transceiver 140 from one unicast/multicast mode to a broadcast mode, and then to a different unicast/multicast mode.

According to an embodiment, the switching of the transceiver 140 may include retuning the transceiver 140 from a first frequency range for the first communication mode to a second frequency range for the second communication mode. For example, the controller 110 may retune the transceiver 140 from the EVDO channel frequency range to the 1x (IS2000) channel frequency range. Additionally, the controller 110 may allocate software clients and internal resources, such as memory, Quality of Service (QoS), logging services, etc., as required by the first and the second communication modes.

According to an embodiment, the switching message may include information associated with the second communication mode. For example, the switching message may be imbedded in the communication data of the first communication mode, to include information specified for establishing the second communication mode, such as frequency range, priority, type of communication, source identification, etc.

According to an embodiment, the switching of the transceiver 140 may be performed according to the information in the switching message. For example, the switching may occur immediately upon detection of the switching message. The switching may occur at a time determined based upon the priority information in the switching message. For example, a high priority flag in the switching message may indicate that the first communication mode should be interrupted to allow establishment of the second communication mode. A lower priority flag in the switching message may indicate that the second communication mode may be established after the first communication mode ends, or that an user approval may be required to establish the second communication mode. The switching message information may be communicated to the user, for example by display or audio, to allow the user to authorize or reject the establishment of the second communication mode.

Furthermore, the user may customize the device 100 and/or the controller 110 to configure appropriate response to detection of the switching message. For example, the user may configure the device 100 such that switching may be disabled. In such a configuration, when the device 100 has no active communication, it may periodically monitor various channels to determine if there are incoming communication in any of its supported communication modes.

According to an embodiment, when switching to the second communication mode, the controller 110 may suspend or interrupt the communication of the first communication mode, by for example saving or storing the session information and the data of the first communication mode in memory or buffer. After the second communication mode ended, the controller 110 may resume the communication of the first communication mode, by retrieving the session information and the data of the first communication mode from the memory or the buffer.

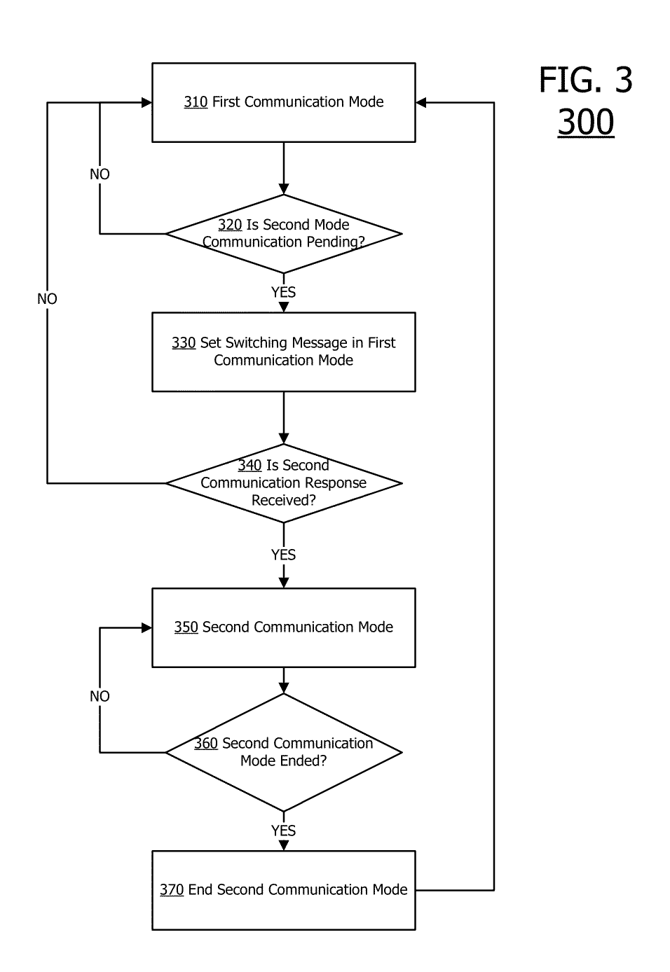

FIG. 3 illustrates a method 300 in accordance with an embodiment of the present disclosure.

The method 300 may include block 310, communicating data through the transceiver 140 configured in a first communication mode specifying and allocating to at least one destination device. At block 320, the controller 110 may determine if there is a pending communication for a second communication mode. If there is no pending communication for a second communication mode, the method may return to block 310.

If there is a pending communication for a second communication mode, at block 330, the controller may set a switching message in the data of the first communication mode. At block 340, the controller 110 may determine if a response corresponding to the switching message is received or not. If no such response is received, the method may return to block 310. If a response corresponding to the switching message is received, the controller 110 may switch the transceiver 140 to establish the second communication mode.

According to an embodiment, the method may proceed to block 350, where a communication may be performed in the second communication mode. At block 360, if the second communication mode has not ended, the method may continue at block 350. At block 370, if the second communication mode has ended, the second communication mode may end, and the method may return to the first communication mode in block 310.

According to an embodiment, the first communication mode may be a data mode, and the data may be received via a plurality of traffic channels to support applications. The second communication mode may be a voice mode. The first and second communication modes may include different communication standards and protocols. For example, the first communication mode may be a EVDO (data only) mode using EVDO standards, and the second communication mode may be a 1x (IS2000) mode.

The device 100 may be communicating data through the transceiver 140 already configured in the first communication mode, for example EVDO (data only) mode through EVDO traffic channels. Such data traffic channels may be dedicated or allocated to one or more specific destination devices. This type of data communication may include for example, unicast type transmission and multicast type transmission. Unicast transmission typically refers to the sending of data to a single specific destination in a single transmission from the source. Multicast transmission typically refers to the sending of data to multiple specific destination device simultaneously in a single transmission from the source. For example, EVDO data traffic channels are dedicated or allocated to specific destination devices when the channels are established between the source device and the specific destination devices.

The data communicated through the allocated channels in first communication mode need not specify the destination devices. As the channels may already be allocated to the specific destination devices, the destination devices may be aware of which data stream and channels are intended for each of them. Thus, the controller 110 may cause the transceiver 140 to set up the data channel to be allocated specifically for another device, and cause the data encoder/decoder 120 and/or the channel encoder/decoder 130 to set a switching message in the data. In such a configuration, the switching message itself also need not specify any specific destination device.

The second communication mode may be a voice mode, such as the 1x (IS2000) mode. The device 100 may communicate in the second communication mode, using traffic channels traffic channels dedicated or allocated to one or more specific destination devices.

According to an embodiment, the switching of the transceiver 140 may include retuning the transceiver 140 from a first frequency range for the first communication mode to a second frequency range for the second communication mode. For example, the controller 110 may retune the transceiver 140 from the EVDO channel frequency range to the 1x (IS2000) channel frequency range. Additionally, the controller 110 may allocate software clients and internal resources, such as memory, Quality of Service (QoS), logging services, etc., as required by the first and the second communication modes.

According to an embodiment, the switching message may include information associated with the second communication mode. For example, the switching message may be imbedded in the communication data of the first communication mode, to include information specified for establishing the second communication mode, such as frequency range, priority, type of communication, source identification, etc.

According to an embodiment, the device 100 may receive pending communication in the second communication, upon a user input on device 100 or on another device (not shown) communicating with the device 100.

According to an embodiment, the switching of the transceiver 140 may be performed according to the information in the switching message. For example, the switching may occur immediately upon detection of the switching message. The switching may occur at a time determined based upon the priority information in the switching message. For example, a high priority flag in the switching message may indicate that the first communication mode should be interrupted to allow establishment of the second communication mode. A lower priority flag in the switching message may indicate that the second communication mode may be established after the first communication mode ends, or that an user approval may be required to establish the second communication mode. The switching message information may be communicated to the user, for example by display or audio, to allow the user to authorize or reject the establishment of the second communication mode.

Furthermore, the user may customize the device 100 and/or the controller 110 to configure appropriate response to detection of the switching message. For example, the user may configure the device 100 such that switching may be disabled. In such a configuration, when the device 100 has no active communication, it may periodically monitor various channels to determine if there are incoming communication in any of its supported communication modes.

According to an embodiment, when switching to the second communication mode, the controller 110 may suspend or interrupt the communication of the first communication mode, by for example saving or storing the session information and the data of the first communication mode in memory or buffer. After the second communication mode ended, the controller 110 may resume the communication of the first communication mode, by retrieving the session information and the data of the first communication mode from the memory or the buffer.

Therefore, according to the embodiments, communication can be efficiently switched between different communication standards and protocols.

1. A method, comprising:
communicating data through a transceiver configured in a first mode, the first mode specifying and allocating to at least one destination device;
parsing application data from the data received in data channels configured in the first mode, by a controller; and
determining whether the data received in the data channels configured in the first mode contains a switching message,
if the data contains the switching message, switching, by the controller, the transceiver to a second mode according to the switching message, and
if the data does not contain the switching message, processing by applications, the data received in the first mode.

2. The method of claim 1, wherein the first mode is a data mode, and the data is received via a plurality of traffic channels to support applications.

3. The method of claim 1, wherein the second mode is a voice mode.

4. The method of claim 1, wherein the switching of the transceiver comprises retuning the transceiver from a first frequency range for the first mode to a second frequency range for the second mode.

5. The method of claim 1, wherein the switching message comprises information associated with the second mode.

6. A method, comprising:
communicating data through a transceiver configured in a first mode, the first mode specifying and allocating to at least one destination device;
if a communication in a second mode is pending, setting, by a controller, a switching message in the data in data channels configured in the first mode; and
if a response corresponding to the switching message is received, switching, by the controller, the transceiver to the second mode.

7. The method of claim 6, wherein the first mode is a data mode, and the data is received via a plurality of traffic channels to support applications.

8. The method of claim 6, wherein the second mode is a voice mode.

9. The method of claim 6, wherein the switching of the transceiver comprises retuning the transceiver from a first frequency range for the first mode to a second frequency range for the second mode.

10. The method of claim 6, wherein the switching message comprises information associated with the second mode.

11. A device, comprising:
a transceiver communicating data in a first mode, the first mode specifying and allocating to at least one destination device; and
a controller parsing application data from the data received in data channels configured in the first mode and determining whether the data received in the data channels configured in the first mode contains a switching message;
wherein if the data contains a switching message, the controller switches the transceiver to a second mode according to the switching message, and
if the data does not contain a switching message, applications process the data received in the first mode.

12. The device of claim 11, wherein the first mode is a data mode, and the data is received via a plurality of traffic channels to support applications.

13. The device of claim 11, wherein the second mode is a voice mode.

14. The device of claim 11, wherein the switching of the transceiver comprises retuning the transceiver from a first frequency range for the first mode to a second frequency range for the second mode.

15. The device of claim 11, wherein the switching message comprises information associated with the second mode.

16. A device, comprising:
a transceiver that communicates data in a first mode, the first mode specifying and allocating to at least one destination device; and
a controller;
wherein if a communication in a second mode is pending, the controller sets a switching message in the data in data channels configured in the first mode; and
if a response corresponding to the switching message is received, the controller switches the transceiver to the second mode.

17. The device of claim 16, wherein the first mode is a data mode, and the data is received via a plurality of traffic channels to support applications.

18. The device of claim 16, wherein the second mode is a voice mode.

19. The device of claim 16, wherein the switching of the transceiver comprises retuning the transceiver from a first frequency range for the first mode to a second frequency range for the second mode.

20. The device of claim 16, wherein the switching message comprises information associated with the second mode.
